(19) United States
(12) Patent Application Publication
(10) Pub. No.: US 2025/0019015 A1
(43) Pub. Date: Jan. 16, 2025

(54) TRUCK SHELL

(71) Applicant: Armadillo Designs, Inc., Bellville, TX (US)

(72) Inventors: Samuel Hunt, Santa Rosa, CA (US); Jonathan Parrella, Bellville, TX (US); Daniel Parrella, Bellville, TX (US); Fabian Araujo, Los Osos, CA (US)

(21) Appl. No.: 18/761,229

(22) Filed: Jul. 1, 2024

Related U.S. Application Data
(60) Provisional application No. 63/523,994, filed on Jun. 29, 2023.

(51) Int. Cl. B62D 33/04; B60J 5/10; B60J 7/04; B60J 7/16

(52) U.S. Cl. CPC B62D 33/046; B60J 5/108; B60J 7/041; B60J 7/1607

(57) ABSTRACT

A truck shell is provided that is able to incorporate a variety of retractable, convertible and/or removable rooftops. The truck shell is designed to be able to drive with or without the rooftop component installed, and with or without the rooftop component in the open or closed position. The truck shell comprises a frame structure which enables its use without a rooftop component installed while retaining structural integrity, and also enabling the use of a number of different structures and styles of rooftops.

### FIELD OF THE INVENTION

The present application relates to components for vehicle shells. More specifically, the present disclosure relates to components for truck shells with a convertible roof.

### BACKGROUND OF THE DISCLOSURE

Transporting items from one place to another in the bed of vehicle is a convenient form of transportation. These items may include anything that can be transported, such as tools, building materials, furniture, animals/livestock, other transportation devices, and the like. However, often times the items are of such a large size that the item or items do not properly fit within the bounds of the bed of the vehicle or may be difficult to secure when loaded to the bed of a vehicle. Further, a common issue is that the items are exposed to the elements, which can cause undesired effects, such as damage, corrosion, extra wear, destruction, or loss/theft.

Current solutions in existence today have a fixed roof system, creating an obstruction for the user, who has to bend down or crawl to access items in the bed of the vehicle. Furthermore, a fixed roof system limits the height of the items being loaded into the vehicle because the items must fit underneath the top of the fixed roof system. Another solution includes toolboxes and tonneau covers to make items more accessible to the user.

Thus, there exists a need for a device that allows for items in the bed of a vehicle to be stored in a manner where they are protected from the elements, can vary in height, and that is accessible to a user.

U.S. Pat. No. 11,260,918 relates to a truck shell adapted for a convertible roof. The shell may be installed over the bed of a pickup truck and has a rigid frame supporting the shell's convertible roof. The frame may have sidewalls that can hinge open, toolboxes that are installed, or have roll doors that revolve around a fitted cylinder.

FIG. 1 illustrates a system 10 from U.S. Pat. No. 11,260,918 for a shell used on the bed of a vehicle. In some implementations, the system 10 can provide a user with an assembly that assists in storing and transporting items in the bed of a vehicle. In some implementations, the system 10 also allows for a variety of items with different shapes and sizes, including but not limited to items such as leisure equipment, furniture, and tools, which may not regularly fit in and be properly secured to the bed of a vehicle, allowing for more storage space. In some implementations, the system 10 may be adjusted to properly fit each type of vehicle beds prior to assembly. Thus, the system 10 may have a modular design. In some implementations, the system 10 includes components that allow for additional items to be stored or transported on the system 10 itself, other than resting or being supported by the bed of the vehicle.

The system 10 allows a user to load a vehicle with secured items according to the size of the bed and customize the types of connections used. In some implementations, parts of the vehicle other than the bed may also be used for transporting items. For example, a cylindrical insert 106 of the system 10 may allow for another storage or transportation method. Thus, additional items such as bikes, surf boards, kayaks, or lumber may be stored or transported using system 10.

FIG. 1 illustrates a perspective view of the system 10, including a pair of sidewalls 102, each with cover railings 114, a pair of cross beams 104, a plurality of inserts 106, one or more hinge plates 110a, 110b, a railing 108, and a sleeve 112. In this implementation, the parts in the system 10 are fabricated from aluminum. In other implementations, the parts in the system 10 may be fabricated from chromoly metal, steel, magnesium, titanium, or other lightweight metal strong enough to at least support a commercial-grade rack and maintain structural integrity as a vehicle shell. Furthermore, the size of the system 10 may be customized to fit the size of different vehicle beds.

The system 10 may be attached to a bed of a vehicle (e.g., a pickup truck). For instance, the sidewalls 102 may be attached to the left and right walls of the bed of a truck. The sidewalls 102 may include windows or other features, and may be a full panel that can be watertight. The sidewalls 102 may attach to the top of the bed of the truck by various mechanisms known in the art. The sidewalls 102 may each have a cover railing 114 attached along a top portion of the sidewall 102 and running horizontally to allow a cover 208, such as a convertible roof, to be retracted and advanced to open and close a space or opening created by the sidewalls 102 and back wall. For instance, the cover railings 114 may allow pegs, rollers, pins, or other mechanisms on the sides of the cover 208 to slide along the cover railings 114. In some examples, the railings 114 may have a channel to allow the peg from the cover 208 to slide along. In some examples, the channel may be different sizes to accommodate different types of covers 208.

Referring to FIG. 2, the shell for a bed of a vehicle may include additional or alternative components, including but not limited to a sidewall 202, a lock 204, a door pin 206, a cover 208 (e.g. a convertible roof), and window 210. A cover 208 may include an accordion style cover that retracts and expands and has pins, knobs or rollers on each panel of the according design, that slide along the cover rails 108.

In some implementations, the system 10 includes components that allow for the shell to be completely watertight and/or weatherproofed when the cover 208 is attached and expanded to cover the top opening formed by the sidewalls and the back wall. In some implementations, the system 10 includes components that allow for the shell to be locked. In some implementations, the system 10 includes components that allow for the shell to maintain its rigidity at different temperatures.

The cover 208 may allow the user to easily access and load larger items into the bed of a vehicle without limitations in height. In some implementations, the convertible roof 208 may include an opening and closing mechanism similar to an accordion-style. For example, the cover 208 may include rectangular sheets or panels, that are connected together by a thin connector and may include a sheet catching mechanism on a back side of the cover 208, such that, in a cover 208 closed position, when the sheets are pushed from a front side of the cover 208, each sheet falls into the sheet catching mechanism, to move to a cover 208 opened position. In this implementation, the cover 208 is fully retracted and in a stored position. As illustrated, the cover 208 in a stored position allows for a user to access the full bed of the vehicle. Additionally, items with a height exceeding the height of the system may still be placed and transported in the vehicle.

FIG. 3 illustrates another example of a system that includes sidewalls 102 and a cover 208, where the cover 208 is an accordion style roof that is partially expanded. The side walls 102 allow for the installation of the cover 208, which is used as a convertible/tonneau roof. As previously described, the side walls 102 (shown in FIG. 1) and cover railings 114 (shown in FIG. 1) may allow pegs, rollers, pins, or other mechanisms on the sides of the cover 208 to slide along the cover railings 114. As illustrated, the cover railings 114 include a channel to secure each end of the cover 208. The cover 208 includes a plurality of panels that make the cover 208 accordion style with the ability to retract, in a stored position, and extend, in a deployed position.

As illustrated, a portion of the plurality of panels of the cover 208 is in a stored position and another portion of the plurality of panels is in a deployed position. In other implementations, more or less panels of the cover 208 may be in the stored position or in the deployed position. A user may move one or more panels of the cover 208 from the deployed position to the stored position by applying a force, in a direction toward the location of the stored panels, sufficient to move the user's desired number of panels into the stored position. The stored panels may be located adjacent to a body of a vehicle where the system is installed. In this implementation, the vehicle is a truck and the system is installed on the bed of the truck. Thus, the stored panels are located near the back window of the truck and opposite of the opening end of the bed of the truck. Similarly, in order to move one or more panels of the cover 208, the user may apply an opposite force, in a direction away from the location of the stored panels, sufficient to move the user's desired number of panels into the stored position.

### SUMMARY OF THE DISCLOSURE

The present application relates to a top that is installed on the top of the bed of a truck sometimes called a truck shell, cap, or camper, but referred to herein for consistency as a truck shell, that is able to incorporate a variety of retractable, convertible and/or removable rooftops. The truck shell is designed to be able to drive with or without a rooftop component installed, and with or without the rooftop component in the open or closed position. The truck shell comprises a frame structure which enables its use without a rooftop component installed while retaining structural integrity, and also enabling the use of a number of different structures and styles of rooftops.

Furthermore, the truck shell allows for a variety of conventional rack systems to be installed above the retractable, convertible and/or removable rooftop, and also within the truck shell base frame for cargo mounting and storage purposes.

### BRIEF DESCRIPTION OF THE FIGURES

FIGS. 1-3 illustrates a system from for a shell used on the bed of a vehicle according to the prior art;

FIG. 4A shows a truck shell according to the present application;

FIG. 4B show various views of a truck shell comprising a roof according to the present application;

FIG. 4C shows a side wall of a truck shell of the present application;

FIG. 5A shows a truck shell according to the present application;

FIG. 5B shows a truck shell installed on a truck bed according to the present application;

FIG. 5C shows a truck shell installed on a truck bed according to the present application;

FIG. 5D shows a truck shell installed on a truck bed according to the present application;

FIG. 6 shows a truck bed with clam shell top installed;

FIGS. 7A-7C show a truck shell of the present application with roof panels; and

FIGS. 8A-8C show truck shells of the present application with various installations.

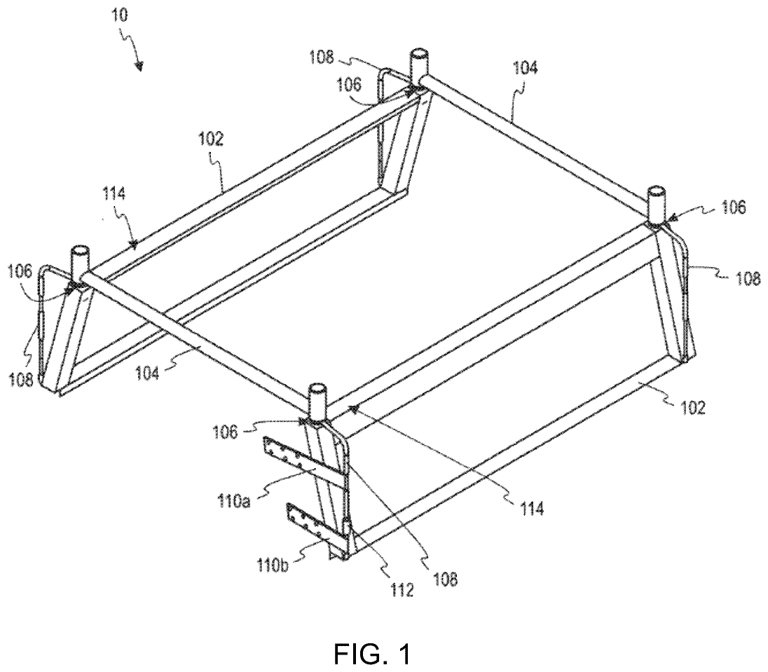

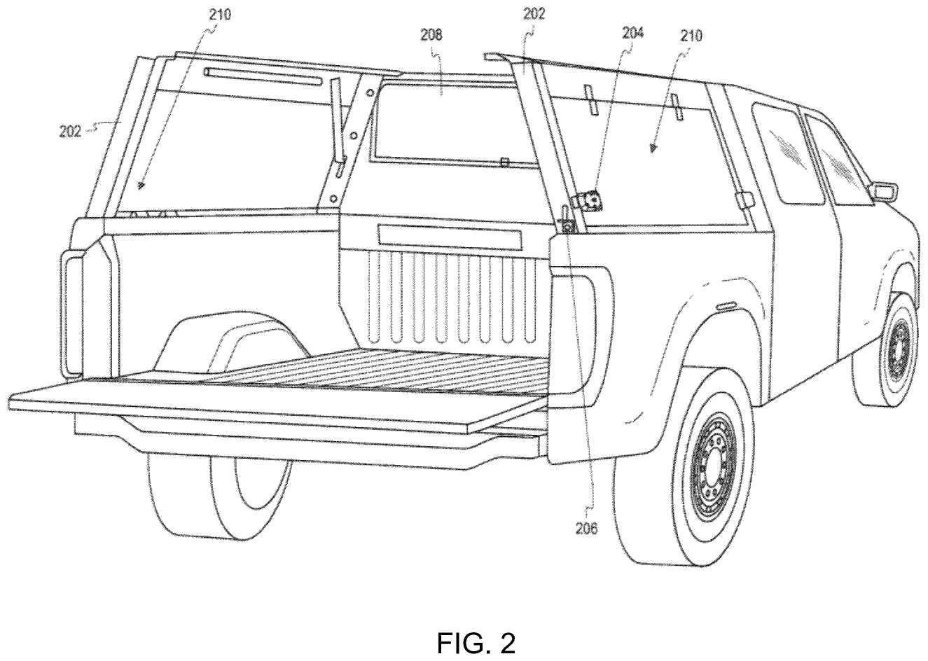

### DETAILED DESCRIPTION OF THE FIGURES

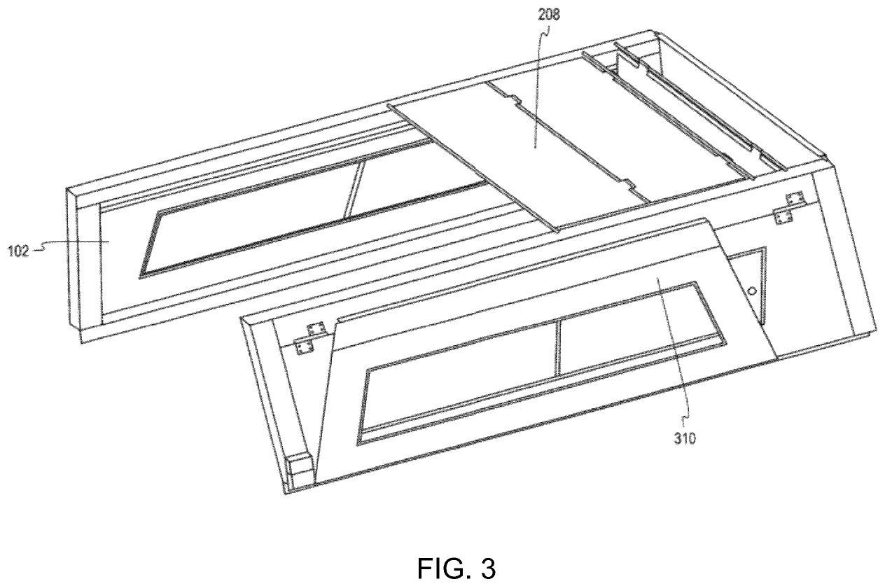

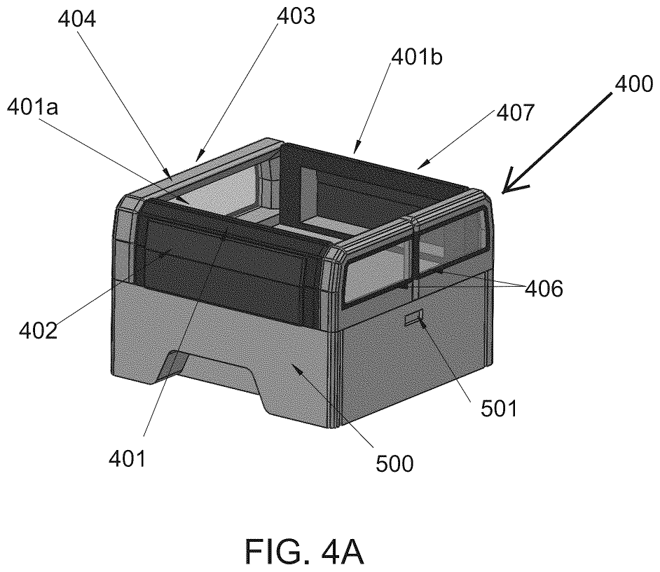

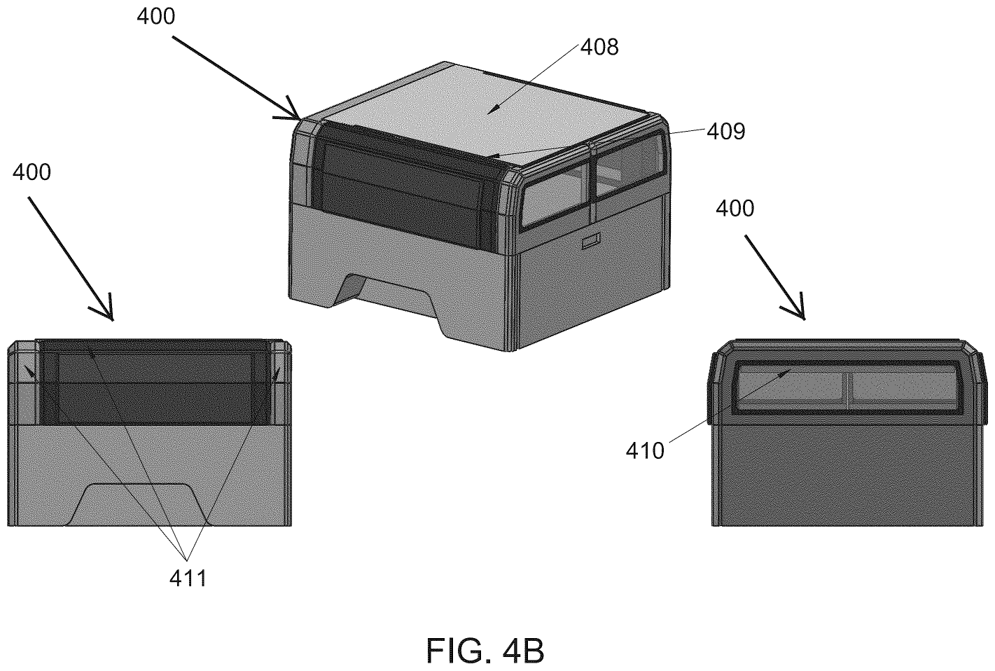

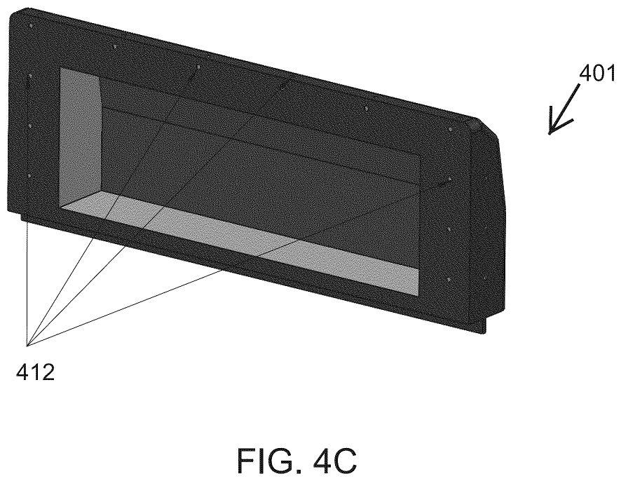

The truck shell of the present application will now be described with reference to FIGS. 4A-8C.

A truck shell 400 according to the present application is shown in FIG. 4A. The truck shell 400 is configured to be mounted to a truck bed 500, which may have a tailgate 501. In general, the truck shell 400 may have a similar function and be made of similar materials as the truck shell 100 described herein in the Background section, but having structural differences which enable the truck shell 400 to be used with any number of rooftop structures, including for example, removable rooftops, collapsible rooftops, and retractable rooftops.

The truck shell 400 comprises a pair of side walls 401 on each side of the truck shell 400, including a driver side wall 401a and a passenger side wall 401b (corresponding generally to the driver and passenger sides of the vehicles). The side walls 401 are configured to be variable in distance until they are coupled to the truck bed 500. The side walls 401 may have hinged doors 402 arranged thereon, configured to open into a storage compartment and/or into the truck shell 400 or truck bed 500. The truck shell 400 also includes a front headache rack/frame or wall 403 comprising a perpendicular cross-member support 404 which is coupled to the side walls 401a, 401b. A rear door section 406 is also provided, which is also coupled to the side walls 401a, 401b. The rear door section 406 is further movable, and can be configured to open, either from a center point where the rear door 406 comprises multiple doors, as shown in FIG. 4A, or from another point such as along one side or along the top or bottom of the truck shell 400.

The truck shell 400 comprises a top opening 407 within the side walls 401, the front wall 403, and the rear door 406. The frame structure of the truck shell 400, comprising the four wall sections 401, 403, 406 provides the truck shell 400 with a stable structural foundation to enable the inclusion of a variety of type of rooftops without being limited to only one particular rooftop structure that may otherwise be necessary for structural integrity of the truck shell 400.

For example, FIG. 4B shows an example of the truck shell 400 having a retractable tonneau cover 408. The retractable cover 408 can be affixed to a top edge 409 of the truck shell 400 using bolds and with vehicle bed clamps. In the example shown in FIG. 4B, the truck shell 400 comprises a forward mounted box 410 into which the retractable roof panels retract. The truck shell 400 includes a modular design 411 of assemblies and components which enables it to be variable in its dimensions and used with multiple rooftops and components.

FIG. 4C shows an example of a side wall 401 of the truck shell 400. The sidewall 401 is comprises a plurality of holes 412 or cylindrical inserts, such as rivet nuts. The cylindrical holes 412 or inserts allow for the mounting of accessories via bolts, compression latches, toggle clamps, straps, or similar hardware therein. Such accessories include, for example, tonneau covers, clam shells, removable roof panels, and/or canvas, to enclose the top opening 407 of the truck shell 400. Additionally, industrial and general rack systems, as well as shelving systems, can be connected to these cylindrical inserts and holes for mounting.

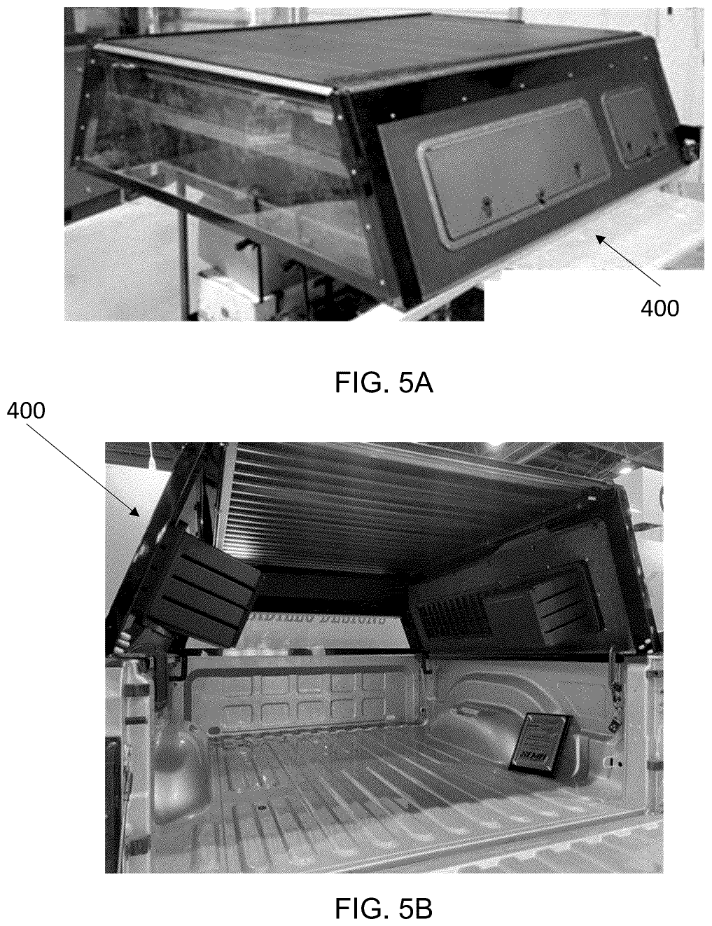

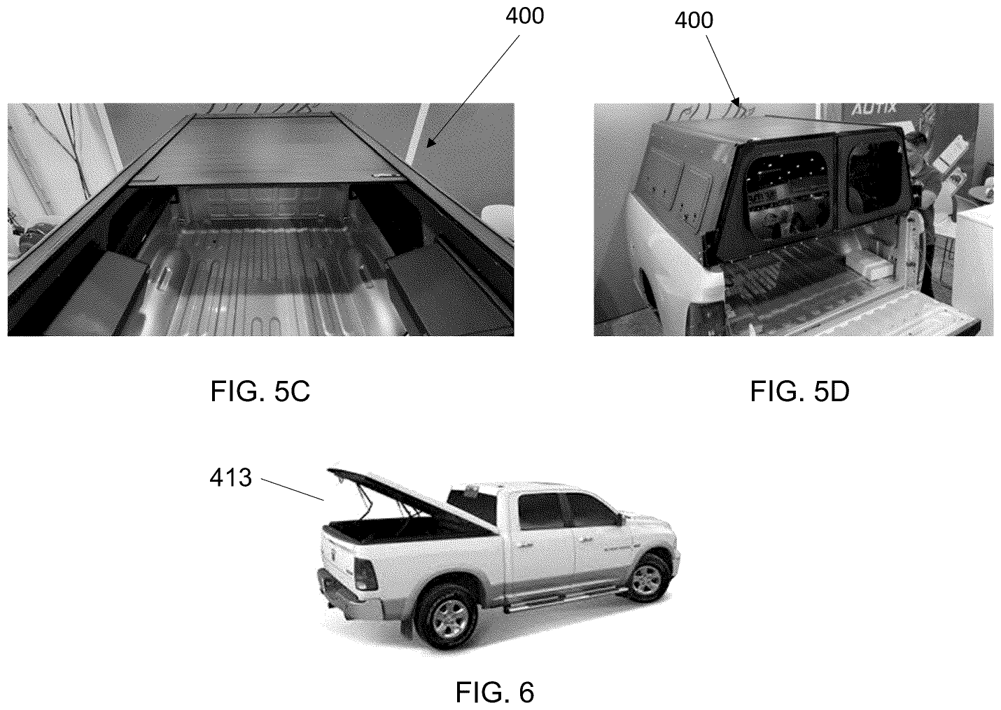

For the rooftop of the truck shell 400, the walls of the truck shell 400 allow for the installation of truck bed tonneau covers, clam shells, removable panels, or similar truck bed products used to enclose the top of the truck bed. For example, FIGS. 5A-5D show a truck shell with a tonneau cover 408 installed, and FIG. 6 shows a truck bed with clam shell top 413 installed.

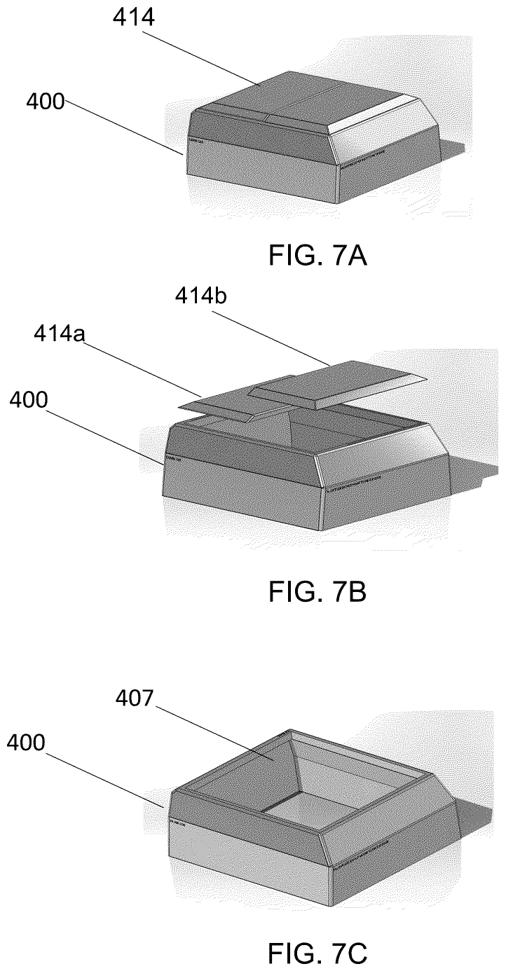

The walls of the truck shell 400 also allow the installation of one or more roof panels 414 that are secured to the top of the truck shell 400 via bolts, compression latches, toggle clamps, straps, or similar hardware therein. This allows user(s) to uncouple the roof panel(s) from the truck shell 400 to create the open-roof feature of the truck shell 400. FIGS. 7A-7C show the truck shell 400 with a roof panel 414 in the closed (FIG. 7A), opening (FIG. 7B), and open positions (FIG. 7C). As shown in FIG. 7B, the roof panel 414 may comprise multiple roof panels 414a, 414b.

The walls of the truck shell 400 also allow the installation of an industrial canvas-type material to enclose the top opening 407 of the truck shell 400. This canvas can be installed in a variety of manners, ranging from bolting in place to straps to zippers.

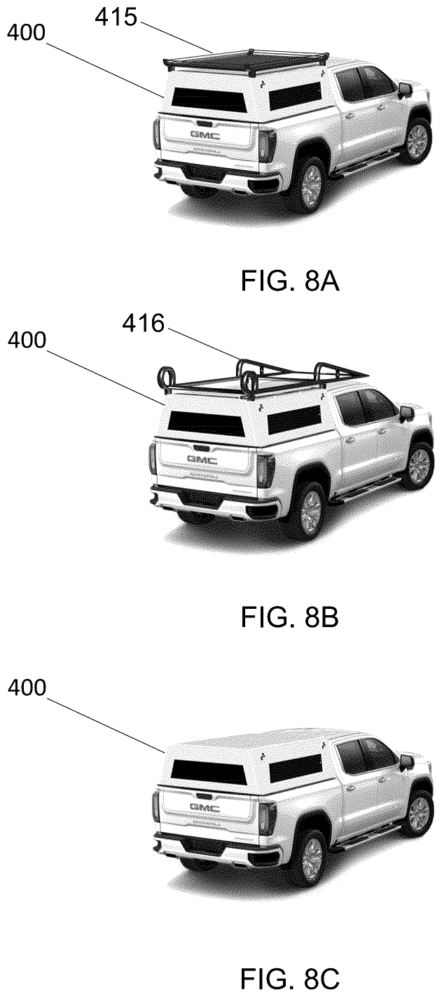

The walls of the truck shell 400 also allow the installation of industrial or general use rack systems to be installed above the rooftop of the truck shell 400. Similar rack systems can also be installed within the truck shell 400, in order to create shelves for the customers/users to utilize for superior storage organization. These rack systems can be moveably coupled or fixed to the inner walls of the base frame. FIGS. 8A-8C illustrate a truck shell 400 with a cargo basket 416 (FIG. 8A), industrial lumber rack 417 (FIG. 8B) and no rack installed (FIG. 8C), highlighting the ability of the frame to accept different rack products.

While there have been shown and described and pointed out fundamental novel features of the invention as applied to embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice.

What is claimed:

1. An apparatus comprising:
a pair of opposing side walls each side wall being configured to be secured to a wall of a bed of a vehicle;
a front frame member adjoining the opposing side walls;
a rear door section, opposing the front frame member and also adjoining the opposing side walls; and
an upper opening formed in between the pair of side walls, the front frame member, and the rear door section;
wherein the side walls comprise a plurality of holes to which a rooftop covering the upper opening is configured to be attached.

2. The apparatus of claim 1,
wherein the rooftop covering is one of a collapsible rooftop covering, a retractable rooftop covering, or a removable rooftop covering; and
wherein the side walls are configured for attachment to each of a collapsible rooftop covering, a retractable rooftop covering, or a removable rooftop covering.

3. The apparatus of claim 2, wherein the removable rooftop covering comprises at least one removable panel.

4. The apparatus of claim 2, wherein the retractable rooftop covering is a tonneau cover.

5. The apparatus of claim 2, wherein the rooftop covering is a clam shell cover.

6. The apparatus of claim 2, wherein the plurality of holes of the sidewall are further configured to mount accessories thereto, wherein the accessories include one or more of a cargo basket or a storage rack.

7. A system comprising:
a truck bed; and
a truck shell mounted atop the truck bed, the truck shell comprising:
a pair of opposing side walls each side wall being configured to be secured to a wall of a bed of a vehicle;
a front frame member adjoining the opposing side walls;
a rear door section, opposing the front frame member and also adjoining the opposing side walls; and
an upper opening formed in between the pair of side walls, the front frame member, and the rear door section;
wherein the side walls comprise a plurality of holes to which a rooftop covering the upper opening is configured to be attached.

8. The system of claim 7,
wherein the rooftop covering is one of a collapsible rooftop covering, a retractable rooftop covering, or a removable rooftop covering; and
wherein the side walls are configured for attachment to each of a collapsible rooftop covering, a retractable rooftop covering, or a removable rooftop covering.
